(19) United States
(12) Patent Application Publication
(10) Pub. No.: US 2020/0311931 A1
(43) Pub. Date: Oct. 1, 2020

(54) METHOD FOR ANALYZING IMAGE OF BIOPSY SPECIMEN TO DETERMINE CANCEROUS PROBABILITY THEREOF

(71) Applicants: aetherAI Co., Ltd., Taipei City (TW); Chang Gung Memorial Hospital, Linkou, Taoyuan City (TW)

(72) Inventors: Chao-Yuan Yeh, Taipei City (TW); Wen-Yu Chuang, Taoyuan City (TW); Wei-Hsiang Yu, Taipei City (TW)

(21) Appl. No.: 16/834,880

(22) Filed: Mar. 30, 2020

Related U.S. Application Data
(60) Provisional application No. 62/827,526, filed on Apr. 1, 2019.

(51) Int. Cl. G06T 7/00; G06N 3/08; G06K 9/62

(52) U.S. Cl. CPC G06T 7/0012; G06K 9/6256; G06K 9/6267; G06N 3/08

(57) ABSTRACT

A method for analyzing an image of a biopsy specimen to determine a probability that the image includes an abnormal region is provided. The method involves a two-stage image analysis and adopts a combination of deep convolutional neural networks and staged and/or parallel computing to perform image recognition and classification. Such two-stage nasopharyngeal carcinoma detection module can detect and predict whole slide images into probabilities related to the nasopharyngeal carcinoma.

### BACKGROUND OF THE INVENTION

### Field of the Invention

The present invention relates to a method for determining the cancerous probability of a biopsy specimen. To be more specific, the present invention relates to a method to detect and predict whole slide images into probabilities with respect to the nasopharyngeal carcinoma.

### Background

Conventional processes for diagnosing Nasopharyngeal Carcinoma rely heavily upon determinations made by physicians based on their visual inspections. Visual inspections on a biopsy specimen, which is collected from the body of a patient to determine whether the collected tissue is cancerous, are generally performed using high magnification optical microscopes. The diagnostic procedure is laborious and time-consuming. Besides, the determinations could be subjective, inconsistent, and may vary from operator to operator due to differences in training, experience, and mental or physical conditions.

In order to obtain more objective results, there are many conventional computer algorithms try to make cancer diagnosis based on digital images.

However, digital whole slide images contain billions of pixels, which is normally hundred times to thousand times of natural images; thus, computational efficiency and accuracy of results with conventional computer algorithms have yet to meet the criteria expected for clinical use.

To improve the efficiency and accuracy for diagnosis, the present invention adopts a combination of deep convolutional neural networks and staged and/or parallel computing to perform image recognition and classification. With the present invention, the two stages nasopharyngeal carcinoma detection module can detect and predict whole slide images into probabilities related to the nasopharyngeal carcinoma.

### SUMMARY OF THE INVENTION

In view of the above problems of the prior art, an analyzing method for to determine the cancerous probability, especially the probability related to the nasopharyngeal carcinoma, of a biopsy specimen is provided.

According to one aspect of the present invention, a method for analyzing an image of a biopsy specimen to determine a probability that the image includes an abnormal region is provided. The method includes the steps of: obtaining a first digitized image of the biopsy specimen, wherein the first digitized image comprises a plurality of target regions corresponding to a defined nasopharyngeal carcinoma region, a defined background region, or a defined normal region, respectively; generating a plurality of training data based on the plurality of target regions; obtaining a first DCNN (deep convolution neural network) model based on the plurality of training data; obtaining a probability map based on the first DCNN model, the probability map displaying at least one cancerous probability of the training data which is predicted by the first DCNN model; and obtaining a second DCNN (deep convolution neural network) model based on the probability map, wherein the second DCNN model determines a first probability that the first digitized image shows a region including a nasopharyngeal carcinoma tissue, or thereby determining a second probability that a second digitized image shows a region including a nasopharyngeal carcinoma tissue.

Preferably, the first digitized image is a digital whole slide image of the biopsy specimen.

Preferably, the method as provided further includes the step of defining the plurality of target regions by drawing the border of a region of interest on the first digitized image and annotating the region of interest as a nasopharyngeal carcinoma region, a defined background region, or a defined normal region.

Preferably, the plurality of training data is generated by a translational shift from a partial area of the target region.

Preferably, the first DCNN model is trained by using a supervised learning method.

The aforementioned aspects and other aspects of the present invention will be better understood by reference to the following exemplary embodiments and drawings.

### BRIEF DESCRIPTION OF THE DRAWINGS

FIG. 1 is a schematic diagram showing the system architecture according to an embodiment of the two-stage image analysis system.

FIG. 2 shows an example of a training process according to the present invention.

FIG. 3 shows an example of a training process according to the present invention.

FIG. 4 shows an example of a training process according to the present invention.

### DETAILED DESCRIPTION OF THE PREFERRED EMBODIMENTS

While this invention will be fully described with preferred embodiments by reference to the accompanying drawings, it is to be understood beforehand that those skilled in the art can make modifications to the invention described herein and attain the same effect, and that the description below is a general representation to those skilled in the art and is not intended to limit the scope of the present invention. It will be understood that the appended drawings are merely schematic representations and may not be illustrated according to actual scale and precise arrangement of the implemented invention. Therefore, the scope of protection of the present invention shall not be construed based on the scale and arrangement as illustrated on the appended drawings and shall not be limited thereto.

### The System

In one aspect of the present invention, a two-stage image analysis system is provided. In one embodiment, the two-stage image analysis system is used for nasopharyngeal carcinoma diagnostic.

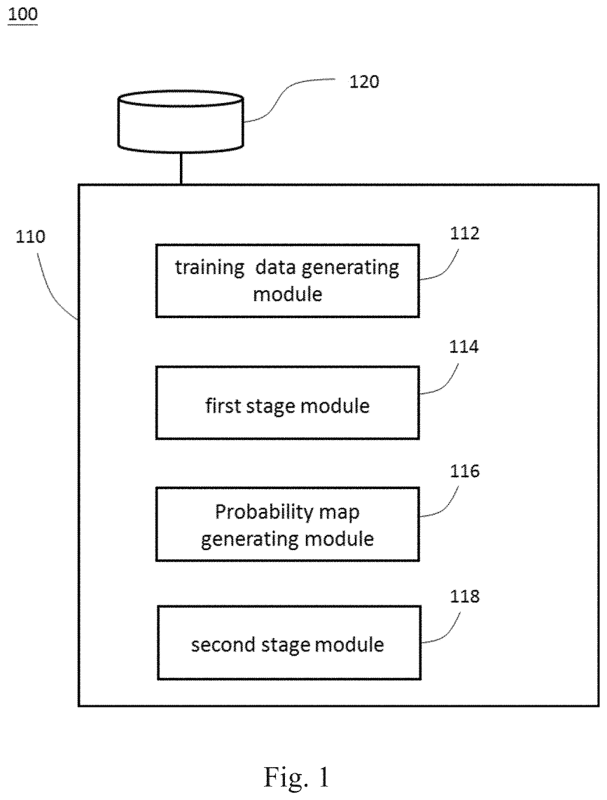

FIG. 1 is a schematic diagram showing the system architecture according to an embodiment of the two-stage image analysis system. The two-stage image analysis system 100 comprises a server 110 and a database 120. The server 110 comprises one or more processors and implements the following modules by means of coordinated operation of hardware and software:
a training data generating module 112, which obtains a first digitized image and generates training data. The first digitized image comprises at least one target region and the training data are generated based on the target region. In an exemplary embodiment, the target region is a defined cancerous region (i.e. defined nasopharyngeal carcinoma region), a defined background region, or a defined normal region.
a first-stage module 114, which trains a first model using the training data, the trained first model will be able to recognize any given partial area of a digitized image to be evaluated as a normal tissue region, a cancer tissue region (i.e. nasopharyngeal carcinoma tissue region), or a background region.
a probability map generating module 116, which generates a probability map using the first model. The probability map displays probabilities of each tile being background, normal tissue, and cancerous tissue.
a second-stage module 118, which trains a second model using the free size inputs by stacking probability map and low-resolution slide images, the trained second model will be able to determine the probability that a given image includes a cancerous tissue (i.e. nasopharyngeal carcinoma tissue) based on the probability map of the given image, so that the determination result can be used for nasopharyngeal carcinoma diagnosis.

In a preferred embodiment, the training data generating module 112 is communicatively connected to the first-stage module 114 and the database 120, the first-stage module 114 is communicatively connected to the probability map generating module 116 and the database 120, the probability map generating module 116 is communicatively connected to the second-stage module 118 and the database 120.

In a preferred embodiment, the system further comprises a database 120 for storing digitized image (such as the first digitized image) and/or training data and/or probability map generated by the probability map generating module 116. In one embodiment, the server further comprises a display module displaying a digitized image overlapping with a probability map corresponding to that image.

In one embodiment, the two-stage image analysis system further comprises a whole slide scanner for scanning biopsy specimens on microscope slides so as to obtain the digitized images thereof, wherein the digitized images are digital whole slide images.

In a preferred embodiment, the system further comprises an interface module for user to define the target region. This interface module can provide an annotating platform for user to draw the border of a region of interest.

In a preferred embodiment, the system further comprises a camera module, a stage for carrying biopsy specimens, an electronic controller, or a combination thereof. The camera module may include an objective lens and an image sensor. The objective lens is adjustable for viewing at high magnifications and low magnifications (e.g. at 5×, 10×, 20×, 40×, 100×.) depending on the field of view of the image to be captured, and may be provided with an auto-focus mechanism for acquiring clear and high-resolution images. The image sensor may be configured to convert the acquired images of the specimen into digital format suitable for processing and storage.

### The Method

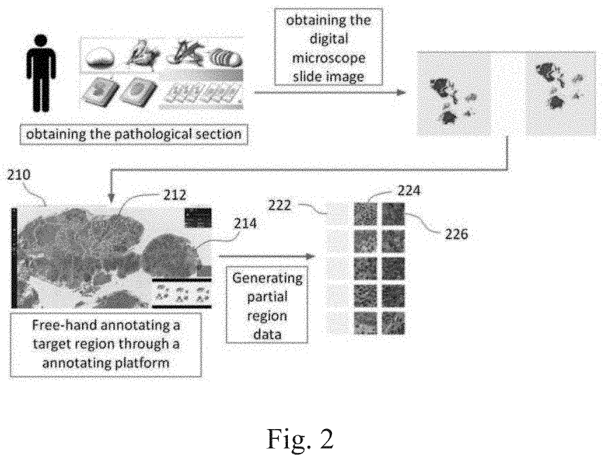

In another aspect, the present invention provides a training process for a two-stage image analysis system and a two-stage image analysis method by using the same. In one embodiment, the two-stage image analysis method is used for nasopharyngeal carcinoma diagnostic. FIGS. 2-4 show an example of a training process according to the present invention.

As shown in FIG. 2, a target sample is first collected from a patient for preparing a biopsy specimen. Then, the biopsy specimen is scanned by a whole slide scanner to obtain a first digitized image thereof.

The first digitized image is then transferred to an annotating platform and annotated freehand by the user (such as a doctor, pathologist, medical staff or the operator of the two-stage image analysis system) to distinguish a target region. For example, the target region may be defined by drawing the border of a region of interest (ROI, such as the region 212 or the region 214 shown in FIG. 2) on the first digitized image 210. In a specific example, the target region may be a cancerous region (i.e. nasopharyngeal carcinoma region), a background region, or a normal region defined by the user (the user may annotates the target region as a nasopharyngeal carcinoma region, a background region, or a normal region).

In an alternative embodiment, the target region may be defined by using other algorithms.

Next, the system generates a plurality of high-resolution images 222, 224 and 226 as training data, each of which has been taken from a partial area of a target region by a translational shift. Preferably, those images overlap in part with each other sequentially. In one embodiment, the target region is divided into tiles of images of fixed sizes, e.g., 256*256 pixels, or 128*128 pixels. The size of the image tile is determined such that its area contains sufficient number of cells to be clearly classified by medical professionals into one of the three categories specified above.

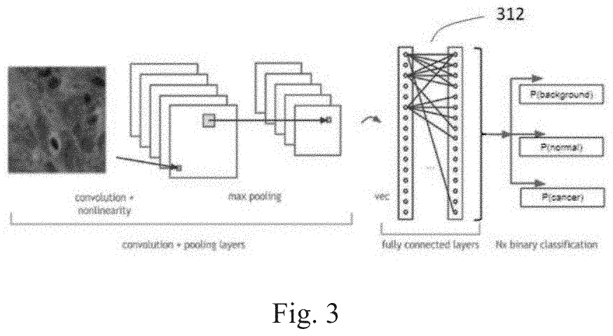

Please refer to FIG. 3, which shows the process trains a first model by using the plurality of high-resolution images as training data to obtain a trained first model. In a preferred embodiment, the first model is a DCNN (deep convolution neural network) model trained by using a supervised learning method. The trained first model will be able to recognize any given partial area of a digitized image (such as the first digitized image or a second digitized image that different from the first digitized image) to be evaluated as a normal tissue region, a cancer tissue region (i.e. nasopharyngeal carcinoma tissue region), or a background region.

Next, a given digitized image (in one embodiment, the given digitized image can be the first digitized image set forth in the preceding paragraph, and the given digitized image is a digital whole slide image) to be evaluated is evenly divided into patches whose sizes are suitable for input to the first model. Each of the patches represents a partial area in the given digitized image. Preferably, each of the divided images (i.e. patches) may or may not overlap with one another. The trained first model is then used to classify each of the divided images into a corresponding inference result (Step 312). In a specific embodiment, the inference result of each divided image includes probabilities for the three categories (e.g., background, normal and cancerous). In an alternative embodiment, an arbitrary score that correlates with probability instead of a probability is displayed.

Thereafter, based on the inference results, a probability map is generated to display cancerous probability, normal tissue probability, and background probability of patches by stitching predictions over divided images. In one embodiment, the cancerous probability map is generated by combining (or piecing together) the inference results corresponding to the original position of each partial area.

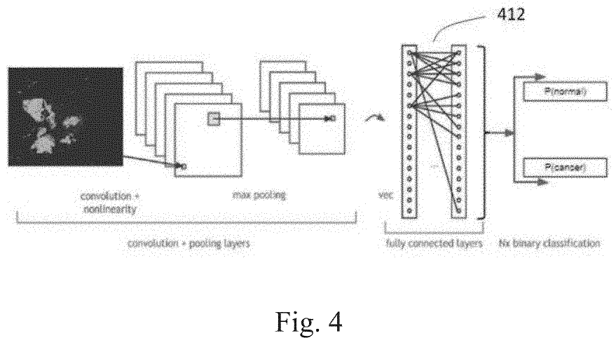

Please refer to FIG. 4, which shows the process trains a second model by using the stacks of probability map and low-resolution slide images as training data to obtain a trained second model. In a preferred embodiment, the trained second model is a trained DCNN (deep convolution neural network) model. The trained second model will be able to determine the probability (Step 412) that a given image (such as the first digitized image or a second digitized image that different from the first digitized image) includes a cancerous tissue (i.e. nasopharyngeal carcinoma tissue) based on the probability map of the given image, so that the determination result can be used for nasopharyngeal carcinoma diagnosis.

In one embodiment, upon receipt of a command, the two-stage image analysis system can display a digitized image of a given biopsy specimen, a probability map of the given biopsy specimen (generated by having the given digitized image undergo the first model training), and/or a combination of the digitized image and the probability map. In a preferred embodiment, the digitized image and the probability map can be displayed in layers and the operator or observer can switch from one layer to another. In another preferred embodiment, the probability map can be displayed together with a quantified value of the cancerous probability inferred from each divided area of the given biopsy specimen. The quantified value of the cancerous probability can be expressed in percentage but is not limited thereto. In another embodiment, the probability of background, normal tissue, and cancerous tissue can be shown in colors (such as a heatmap).

In one embodiment of the present invention, the server and the database of the two-stage image analysis system are provided on the same apparatus.

It will be understood that the above description of embodiments is given by way of example only and that various modifications may be made by those with ordinary skill in the art. The above specification, examples, and data provide a complete description of the present invention and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A method for analyzing an image of a biopsy specimen to determine a probability that the image includes an abnormal region, comprising the steps of:
obtaining a first digitized image of the biopsy specimen, wherein the first digitized image comprises a plurality of target regions corresponding to a defined nasopharyngeal carcinoma region, a defined background region, or a defined normal region, respectively;
generating a plurality of training data based on the plurality of target regions;
obtaining a first DCNN (deep convolution neural network) model based on the plurality of training data;
obtaining a probability map based on the first DCNN model, the probability map displaying at least one cancerous probability of the training data which is predicted by the first DCNN model; and
obtaining a second DCNN (deep convolution neural network) model based on the probability map, wherein the second DCNN model determines a first probability that the first digitized image shows a region including a nasopharyngeal carcinoma tissue, or thereby determining a second probability that a second digitized image shows a region including a nasopharyngeal carcinoma tissue.

2. The method of claim 1, wherein the first digitized image is a digital whole slide image of the biopsy specimen.

3. The method of claim 1, further comprising:
defining the plurality of target regions by drawing the border of a region of interest on the first digitized image and annotating the region of interest as a nasopharyngeal carcinoma region, a defined background region, or a defined normal region.

4. The method of claim 1, wherein the plurality of training data is generated by a translational shift from a partial area of the target region.

5. The method of claim 1, wherein the first DCNN model is trained by using a supervised learning method.
